(19) United States
(12) Patent Application Publication
(10) Pub. No.: US 2016/0154133 A1
(43) Pub. Date: Jun. 2, 2016

(54) SYSTEMS AND METHODS OF PROVIDING COMPENSATED GEOLOGICAL MEASUREMENTS

(71) Applicant: HALLIBURTON ENERGY SERVICES, INC., Houston, TX (US)

(72) Inventors: Burkay DONDERICI, Houston, TX (US); Paul RODNEY, Spring, TX (US)

(73) Assignee: Halliburton Energy Services, Inc., Houston, TX (US)

(21) Appl. No.: 14/347,037

(22) PCT Filed: May 7, 2013
(86) PCT No.: PCT/US2013/039888

§ 371 Date: Mar. 25, 2014

(51) Int. Cl. G01V 1/50; G01V 3/38; G01V 3/30

(52) U.S. Cl. CPC G01V 1/50; G01V 3/30; G01V 3/38

(57) ABSTRACT

Disclosed are systems and method for providing compensated measurements for more accurate downhole measurement data. One measurement system includes at least two transmitters and at least two receivers disposed within at least one borehole formed in a subterranean formation, and a data acquisition system communicably coupled to the at least two transmitters and the at least two receivers and configured to activate the at least two transmitters and process time-lapsed signals received from the at least two receivers in order to generate compensated signals that minimize or eliminate multiplicative effects.

### BACKGROUND

The present disclosure is related to making measurements related to oil and gas exploration and, more particularly, to providing compensated measurements for effectively reducing errors in measurement data.

The oil industry has been gathering various forms of downhole information for many years. Modern petroleum drilling and production operations demand a great quantity of information relating to the parameters and conditions downhole. Such information typically includes the location and orientation of the wellbore and drilling assembly, earth formation properties, and drilling environment parameters downhole. However, the environment in which the drilling tools operate is at significant distances below the surface. Controlled source electromagnetics (CSEM) is a technique that can be applied to evaluate resistivity variations deep underground, where the CSEM technique uses sensors that are separated by predetermined distances. For example, CSEM may be used to predict reservoir fluid properties and to detect resistivity of hydrocarbon deposits in subterranean formations.

For complete evaluation of subterranean formations that span a large area, multiple transmitters or receivers are typically used or needed to monitor formation changes, including those related to water flooding, steam, and electromagnetic waves. The location of these transmitters and receivers varies the effect and sensitivity to formation properties. As a result, various changes to the signal between transmitters and receivers may develop, such as amplitude or phase shift attributable to electronic drift, drift as a result of temperature change, or unknown phase or unknown amplitude. The measurements can also be affected by the strength of the transmitters and receivers, and any differences in manufacturing or electronics of such devices. As can be appreciated, the usefulness of such measurements can be related to the precision or quality of the data derived from such measurements.

### SUMMARY OF THE DISCLOSURE

The present disclosure is related to making measurements related to oil and gas exploration and, more particularly, to providing compensated measurements for effectively reducing errors in measurement data.

In some embodiments, a measurement system is disclosed and may include at least two transmitters and at least two receivers disposed within at least one borehole formed in a subterranean formation, wherein at least one of the at least two transmitters or the at least two receivers is permanently installed in the at least one borehole, and a data acquisition system communicably coupled to the at least two transmitters and the at least two receivers and configured to activate the at least two transmitters and process two or more signals received from the at least two receivers in order to generate compensated signals that minimize or eliminate multiplicative effects, wherein at least one time-lapsed compensated signal is generated from a difference between a first compensated signal and a second compensated signal.

In some embodiments, a method of monitoring a subterranean formation is disclosed. The method may include activating at least two transmitters with a data acquisition system communicably coupled thereto, collecting signals received by at least two receivers with the data acquisition system, wherein the at least two transmitters and the at least two receivers are disposed within at least one borehole formed in the subterranean formation, and generating compensated signals from the signals collected with the data acquisition system.

The features of the present disclosure will be readily apparent to those skilled in the art upon a reading of the description of the embodiments that follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a block diagram of an exemplary data acquisition system used for downhole sensing of resistive anomalies and compensating for measurement variations, according to one or more embodiments.

FIG. 2 illustrates an exemplary measurement system for monitoring a subterranean formation, according to one or more embodiments.

FIG. 3 illustrates a schematic of a method of compensating for effects on measured signals, according to one or more embodiments.

FIG. 4 illustrates a flow chart describing various preprocessing actions that may be undertaken, according to one or more embodiments.

FIG. 5 illustrates an attenuation plot and a phase plot that provide modeling results derived from the monitoring application of FIG. 2, according to one or more embodiments.

FIGS. 6A-6D illustrate exemplary measurement systems for monitoring a subterranean formation, according to one or more embodiments.

FIG. 7 illustrates a block diagram of an exemplary system used to process received signals at sensors to compensate for multiplicative effects and other perturbations on various measuring tools, according to one or more embodiments of the disclosure.

### DETAILED DESCRIPTION

The present disclosure is related to making measurements related to oil and gas exploration and, more particularly, to providing compensated measurements for effectively reducing errors in measurement data.

The present disclosure provides systems and methods for making compensated measurements for monitoring subterranean formations or regions. The exemplary disclosed systems include transmitters and receivers (e.g., sensors) that may be permanently installed in a wellbore in order to monitor changes to the surrounding subterranean formation or region. Changes to the subterranean formation or region may result from one or more downhole operations including, but not limited to, fluid flooding (e.g., water or chemical), steam injection, an influx of electric, magnetic, or electromagnetic energy, combinations thereof, and the like. The various sensors may be configured to transmit or otherwise operate with electromagnetic or acoustic waves in order to log and compare time-lapsed measurements of the formation.

The exemplary disclosed methods may utilize a compensation process when interpreting the various changes in the signals transmitted between the transmitter(s) and receiver(s) over time. As will be appreciated by those skilled in the art, the compensation process or methodology may prove advantageous in eliminating confounding or multiplicative effects of any type of amplitude or phase shift that is attributable to electronic drift, drift as a result of temperature change, or unknown phases or amplitudes. The compensation process or methodology may also prove advantageous in minimizing or eliminating the multiplicative effects of elements such as manufacturing and electronic/component differences of the transmitters and receivers, thereby ensuring that the remaining changes observed and measured are relevant to the monitoring application. After the exemplary compensation process is performed or otherwise undertaken, the changes observed in the resulting signals may provide the basis for accurate measurements for use in monitoring the subterranean formation. Accordingly, the compensation process may help ease operational requirements on electronics and result in simpler and more robust formation measurements over time.

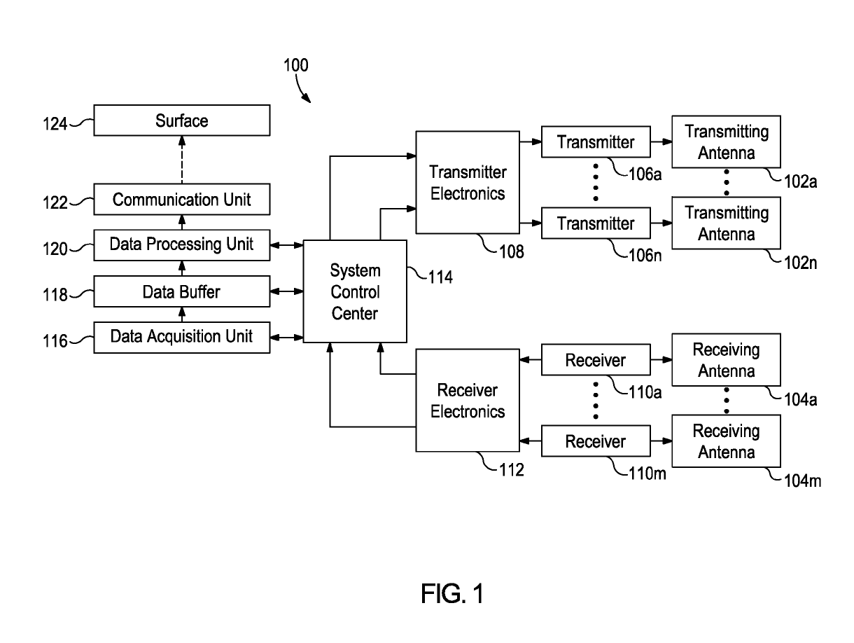

Referring to FIG. 1, illustrated is a block diagram of an exemplary data acquisition system 100 that may be used for downhole sensing of resistive anomalies and compensating for measurement variations, according to one or more embodiments. As used herein, the phrase “resistive anomaly” refers to a subterranean region or mass which exhibits a detectable difference in resistivity from an adjacent subterranean region or mass. Resistive anomalies include, but are not limited to, localized anomalies, such as pockets, cavities, inclusions, fractures, and may also include boundaries between different earth formations or strata, such as faults, gas-oil contacts, oil-water contacts, salt domes, hydrocarbon sources, water sources (e.g., water flooding), dipping bed boundaries, etc. Those skilled in the art will readily appreciate that the system 100 as described herein is merely one example of a wide variety of data acquisition systems that can operate in accordance with the principles of this disclosure. Accordingly, the data acquisition system 100 is not to be limited solely to the specific details described herein and other changes or alterations to the structure and processing capabilities may be introduced without departing from the scope of the disclosure.

As illustrated, the data acquisition system 100 may include at least one transmitting antenna 102ₐ-102ₙ and at least one receiving antenna 104ₐ-104ₘ. As used herein, the term “antenna” refers to an interface element by which a signal may be sent or received. In some embodiments, the signal may be an electromagnetic signal. In other embodiments, however, the signal may be acoustic signals, without departing from the scope of the disclosure. Each transmitting antenna 102ₐ₋ₙ may be driven by a corresponding transmitter 106ₐ-106ₙ, and each transmitter 106ₐ₋ₙ may be configured to transmit at least one signal at a particular frequency. For example, the transmitted frequency may range between about 0.01 Hz and about 100 Hz, especially for detection of resistivity contrasts from distances larger than 10 feet, but could range upwards to about 500 Hz or to about 1000 Hz. In other embodiments, the transmitted frequency may range between about 1 kHz and about 120 kHz, especially for detection of resistivity contrasts from distances larger than 1 foot. As will be appreciated, depending on the monitoring application, multiple signals may be transmitted at different frequencies, such as 5 kHz, 15 kHz, and 45 kHz, and even as much as 200 kHz, without departing from the scope of the disclosure. For acoustic sensors, a suitable frequency range may range from about 100 Hz to about 10,000 Hz, or range between about 500 Hz and about 5,000 Hz.

Each receiving antenna 104ₐ₋ₘ may be coupled to a dedicated receiver 110ₐ₋ₘ or a single receiver 110 may be coupled to multiple receiving antennas 104ₐ₋ₘ. It should be noted that the number “m” of receiving antennas 104ₐ₋ₘ may be the same as, or different from, the number “n” of transmitting antennas 102ₐ₋ₙ. It is also not necessary for the number of receiving antennas 104ₐ₋ₘ to be the same as the number of receivers 110ₐ₋ₘ, or for the number of transmitting antennas 102ₐ₋ₙ to be the same as the number of transmitters 106ₐ₋ₙ. Rather, any number of these elements or components may be used or otherwise employed without departing from the scope of the disclosure. In some cases, for example, some transmitting antennas 102ₐ₋ₙ may be configured to also serve as receiving antennas 104ₐ₋ₘ.

In some embodiments, the transmitting antennas 102ₐ₋ₙ and the receiving antennas 104ₐ₋ₘ may be configured to approximate a magnetic dipole. As used herein, a “magnetic dipole” is defined as a pair of magnetic poles, of equal magnitude but of opposite polarity, separated by a relatively small distance. The transmitting antennas 102ₐ₋ₙ and the receiving antennas 104ₐ₋ₘ may include, for example, a magnetometer (in the case of a receiver), or a coil or a solenoid antenna to approximate a magnetic dipole. A magnetic dipole antenna is referenced by the letter “H,” as will be described below.

In other embodiments, the transmitting antennas 102ₐ₋ₙ and the receiving antennas 104ₐ₋ₘ may be configured to approximate an electric dipole. As used herein, an “electric dipole” is defined as a pair of electric charges, of equal magnitude but of opposite sign, separated by a relatively small distance. “Electric dipole” can also be defined as a pair of current sources, of equal magnitude but of opposite sign, separated by a relatively small distance. The transmitting antennas 102ₐ₋ₙ and the receiving antennas 104ₐ₋ₘ may include, for example, a wire antenna, a toroidal antenna wrapped around a conductor, a button electrode, or a ring electrode to approximate an electric dipole. An electric dipole antenna is referenced by the letter “E,” as will be described below.

The transmitters 106ₐ₋ₙ and receivers 110ₐ₋ₘ may include or otherwise encompass various forms of magnetic dipole sensors and/or electric dipole sensors, depending on the application. For example, the magnetic dipole sensors and/or electric dipole sensors may include, but are not limited to, tilted coil antennas, non-tilted coil antennas, solenoid antennas, toroidal antennas, electrode-type antennas, transceivers, or combinations thereof. As will be appreciated by those skilled in the art, the selection of the type of transmitter sensor or receiver sensor may depend on the monitoring application.

The data acquisition system 100 may further include transmitter electronics 108 that may include, for example, one or more of a signal generator, a demultiplexer, a digital to analog converter, and other modules or devices used to support operation of the transmitters 106ₐ₋ₙ. In some embodiments, the signal generator (not shown) may be configured to generate the signals for transmission by the transmitters 106ₐ₋ₙ, the digital-to-analog converter (DAC) (not shown) may be configured to convert digital signals to analog signals, and the demultiplexer (not shown) may be configured to selectively couple the signal generator to the transmitters 106ₐ₋ₙ. As will be appreciated, any combination of one or more signal generators, digital to analog converters, DACs, and demultiplexers may be used to drive the transmitters 106ₐ₋ₙ. Alternatively, the transmitters 106ₐ₋ₙ may each perform the function of the signal generator, and the separate signal generator as part of the transmitter electronics 108 may be omitted from the data acquisition system 100.

The receivers 110ₐ₋ₙ may be coupled to receiver electronics 112, which may include, for example, an analog-to-digital converter (not shown), and other modules or devices used to support operation of the receivers 110ₐ₋ₙ. A system control center 114 may communicably couple the receiver electronics 112 to the transmitter electronics 108 and thereby control overall operation of the data acquisition system 100. As illustrated, the system control center 114 may further be communicably coupled to at least a data acquisition unit 116, a data buffer 118, and a data processing unit 120, thereby placing the receiver electronics 112 also in communication with such components. In some embodiments, the data acquisition unit 116 may be configured to determine an amplitude and/or a phase of a received signal. The acquired signal information may be stored, along with acquisition time information in the data buffer 118. The data buffer 118 may be useful when formation characteristics are determined based on signals received at different times and/or at different positions within a wellbore.

Data processing may be performed at the surface or at a downhole location where the data acquisition system 100 is arranged. If the data processing is to be performed at the surface, the acquired signal information from the receiver electronics 112, the data acquisition unit 116, and the buffered signal information from the data buffer 118 may be conveyed to a communication unit 122 which may be configured to transmit the data to the surface 124 and to a computer or other processing system (not shown) arranged at the surface 124. If the data processing is to be performed downhole, the data processing unit 120, in conjunction with the other components of the data acquisition system 100, may be configured to perform the necessary data processing. Both the computer at the surface 124 and the system control center 114 may include multiple processors and a memory configured to receive and store data. The memory may be any non-transitory machine-readable medium that has stored therein at least one computer program with executable instructions that cause the processor(s) to perform the data processing on the received signals. The memory may be, for example, random access memory (RAM), flash memory, read only memory (ROM), programmable read only memory (PROM), electrically erasable programmable read only memory (EEPROM), registers, hard disks, removable disks, a CD-ROM, a DVD, any combination thereof, or any other suitable storage device or medium.

Since the system control center 114 is coupled to various components of the system 100, the system control center 114 may be configured to adjust or otherwise regulate various parameters of the system 100 in order to optimize operation. For example, the system control center 114 may control the frequencies generated by the signal generator in the transmitter electronics 108 or the transmitters 106ₐ₋ₙ. The system control center 114 may also control the timing of the transmitters 106ₐ₋ₙ. For instance, the system control center 114 may cause the transmitters 106ₐ₋ₙ to operate sequentially or according to a predetermined transmission sequence such that time-lapse measurements or signals may be obtained by the receivers 110ₐ₋ₙ.

In operation, the data acquisition system 100 may control the operation of the transmitters 106ₐ₋ₙ and process signals obtained by the receivers 110ₐ₋ₙ. From the received signals, information about the subterranean formation where the transmitters 106ₐ₋ₙ and receivers 110ₐ₋ₙ operate may be extracted. According to embodiments of the present disclosure, the data acquisition system 100 may further be configured to process the received signals and provide compensated signals that minimize or eliminate amplitude or phase shift that is attributable to electronic drift, drift as a result of temperature change, or unknown phase or unknown amplitude changes due to the instrumentation, and further minimize any effects of manufacturing and electronic differences exhibited by the transmitters 106ₐ₋ₙ and receivers 110ₐ₋ₙ. As a result, the data acquisition system 100 may generate more accurate measurements.

In particular, the data processing unit 120, in conjunction with the system control center 114, may process the received signals by generating a ratio of the measured signals to compensate for the above-noted potentially adverse effects. The generated ratio or ratios provide compensated signals on which the data processing unit 120 can perform an inversion operation to determine parameters or properties of the subterranean formation in which the system 100 operates. The data processing unit 120 may further be configured to apply an inversion operation on the compensated signals to determine properties of the formation or elements in the formation, such as an oncoming or progressing flood. As used herein, the term “flood” refers to any type of process where pressure is induced around the borehole to produce movement of material that results in a change in resistivity of the formation, such as water flooding, steam flooding, chemical flooding, etc.

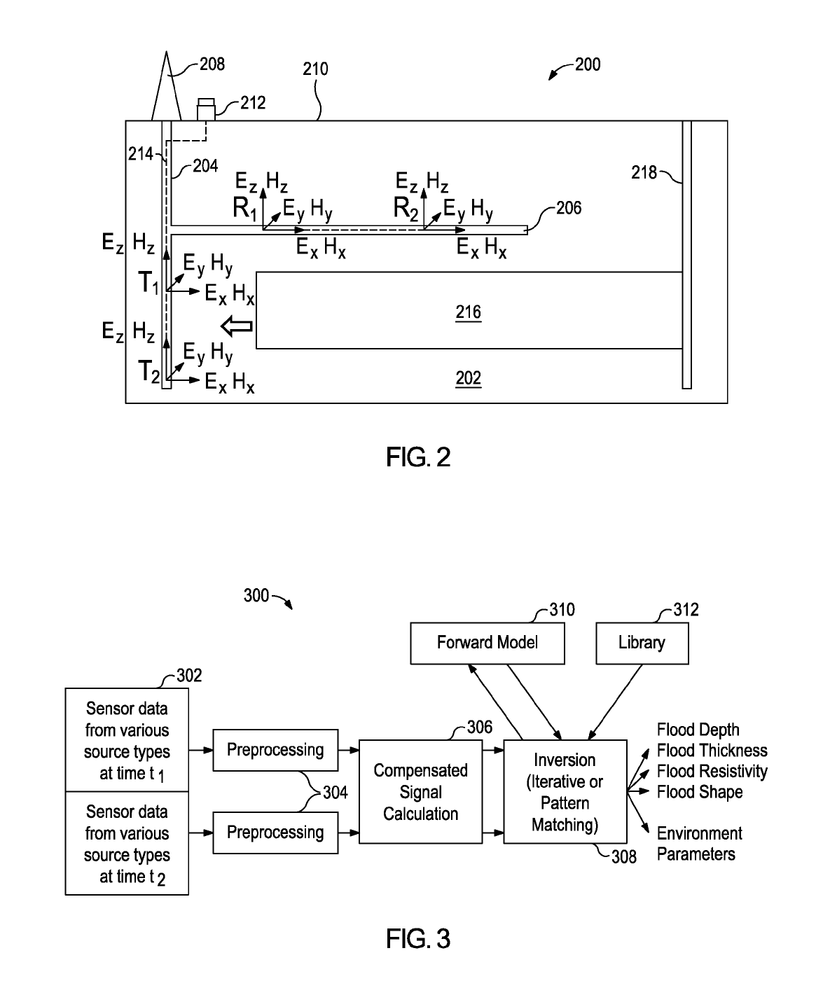

Referring now to FIG. 2, with continued reference to FIG. 1, illustrated is an exemplary measurement system 200 for monitoring a subterranean formation 202, according to one or more embodiments. The measurement system 200 may be configured to employ the principles and processing capabilities of the data acquisition system 100 of FIG. 1. As illustrated, the measurement system 200 may include at least two transmitters T₁ and T₂ and at least two receivers R₁ and R₂. The transmitters T₁, T₂ and receivers R₁, R₂ may be similar to the transmitters 106ₐ₋ₙ and receivers 110ₐ₋ₙ of FIG. 1, and therefore will not be described again in detail. In some embodiments, one or more of the transmitters T₁, T₂ and/or one or more of the receivers R₁, R₂ may be a transceiver having the ability to operate as both a transmitter and a receiver.

Each of the transmitters T₁, T₂ and receivers R₁, R₂ may include at least three antennas positioned in three perpendicular orientations corresponding, in this example, to the x, y, and z axes, respectively. The antennas are represented in FIG. 2 as Eₓ, Hₓ, E_{y}, H_{y}, E_{z}, and H_{z}, where “E” represents an electric dipole antenna and “H” represents a magnetic dipole antenna. As will be appreciated, the antennas of FIG. 2 may be substantially similar to the transmitting antennas 102ₐ₋ₙ and receiving antennas 104ₐ₋ₘ of FIG. 1, and therefore will not be described again in detail. In some embodiments, the transmitters T₁, T₂ and receivers R₁, R₂ may be co-linear or co-planar. In other embodiments, however, the transmitters T₁, T₂ and receivers R₁, R₂ are not necessarily co-linear and/or co-planar.

In the illustrated embodiment, the transmitters T₁, T₂ are arranged in a production well 204 and the receivers R₁, R₂ are arranged in a lateral well 206 extending at an angle from the production well 204. A service rig 208 may be arranged at a surface 210 and structurally/fluidly coupled to the production well 204 and configured to facilitate service and production operations on the production well 204. As described below, in some embodiments the production well 204 and the lateral well 206 may be separate wells. Each of the transmitters T₁, T₂ and receivers R₁, R₂ may be permanently disposed or otherwise arranged within the production and lateral wells 204, 206, respectively. As used herein, the term “permanent” refers to an emplacement that will not move for long periods of time, such as throughout the duration of a particular wellbore operation (i.e., hydrocarbon production, flooding operations, stimulation operations, fracturing operations, etc.). In some embodiments, “permanent” indicates that the particular sensor or tool is not disposed on a wireline or other movable wellbore conveyance or arranged on a bottomhole assembly that is able to translate axially within the borehole.

In some embodiments, for example, the transmitters T₁, T₂ and receivers R₁, R₂ may be coupled to casing string (not shown) cemented into each of the production and lateral wells 204, 206, respectively. For example, the transmitters T₁, T₂ and receivers R₁, R₂ may be arranged within corresponding housings (not shown) that are coupled to the casing string and configured to protect the transmitters T₁, T₂ and receivers R₁, R₂ from contamination and/or damage. In other embodiments, the transmitters T₁, T₂ and receivers R₁, R₂ may be disposed within or otherwise deployed into the physical geographic structure of the borehole for each of the production and lateral wells 204, 206, respectively. In yet other embodiments, the transmitters T₁, T₂ and receivers R₁, R₂ may be permanently coupled to any other portion, device, or tool associated with the production and lateral wells 204, 206, respectively.

Moreover, some or all of the electronics necessary to operate the transmitters T₁, T₂ and receivers R₁, R₂, such as portions of the data acquisition system 100 of FIG. 1, may also be permanently emplaced in the downhole environment and in communication with the transmitters T₁, T₂ and receivers R₁, R₂ for appropriate operation. In other embodiments, the transmitters T₁, T₂ and receivers R₁, R₂ may be communicably coupled to one or more computers or data processing units 212 arranged at the surface 210 via one or more communication and/or power lines 214. The communication lines 214 may be any form of wired or wireless technology allowing the transmitters T₁, T₂ and receivers R₁, R₂, or the communication unit 122 of FIG. 1, to communicate with the data processing unit 212 and/or an operator at the surface 210. Accordingly, the surface 210 of FIG. 2 may be similar to the surface 124 of FIG. 1.

In operation, the transmitters T₁, T₂ and receivers R₁, R₂ may be configured to make measurements at different times to measure changes in the subterranean formation 202, such as in the case of an approaching flood 216. As illustrated, the flood 216 may be introduced into the formation 202 via an injection well 218 extending from the surface 210. In some embodiments, the fluid of the flood 216 may be water in liquid and/or gas form and the flood 216 may form part of a steam-assisted gravity drainage (SAGD) operation, as known to those skilled in the art. In other embodiments, the fluid of the flood 216 may be a chemical or other fluid used in enhanced oil recovery (EOR) operations. As known to those skilled in the art, flooding subterranean formations is generally done to increase hydrocarbon production and entails injecting a fluid (e.g., water, chemicals, etc.) to push the reserves toward the production well 204 for production. For efficient production operations, it can be advantageous to know when the flood 216 is approaching the production well 204 so that preventative measures may be undertaken to avoid producing unwanted fluids to the surface 210.

The transmitters T₁, T₂, each operating as a dipole antenna source, may be activated to transmit a low-frequency electromagnetic field into the subterranean formation 202. The generated dipole field interacts with the formation 202 and a resulting field can be measured at the receivers R₁, R₂. The characteristics of the acquired field measurements can be used to determine time lapsed information regarding the formation 202, such as, but not limited to, where the flood 216 is located. Signals comprising the acquired field measurements may be provided by the receivers R₁, R₂ to the data processing unit 120 (FIG. 1) for analysis corresponding to characteristics of the formation 202, such as its electrical resistivity (or in terms of its electrical conductivity), or characteristics of the flood 216, such as its volume distribution of electrical resistivity. The resistivity (conductivity) data can be used to determine resistivity contrast between oil- or gas-saturated rocks and those with a significant fluid or water content (i.e., indicative of the flood 216).

According to embodiments disclosed herein, the measurement system 200, as operated by or in conjunction with the data acquisition system 100 of FIG. 1, may be configured to process signals received from the receivers R₁, R₂ and, by using a certain ratio of at least four measurements obtained, provide compensated measurements configured to compensate for a variety of measurement errors that may occur. Such compensation processing, as disclosed herein, may be used to eliminate the effects of changes in the field or signal between the transmitters T₁, T₂ and receivers R₁, R₂ that are not related to the approaching flood 216 to provide precise location or distribution information of the flood 216. As a result, more accurate, deeper, and reliable measurements as compared to conventional methods may be obtained largely independent of sensor performance, strength and timing, and are able to operate without the use of expensive device components to compensate for sensor or synchronization effects.

Those skilled in the art will readily appreciate, however, that although the systems and methods disclosed herein can be used to monitor the movement of fluids in the formation 202, such as during a flooding 216 operation, the same principles may be applied to other downhole or surface monitoring applications, without departing from the scope of the disclosure.

The compensation process requires at least two transmitters T₁, T₂ and two receivers R₁, R₂ that provide both amplitude and phase measurements. Signals obtained from the transmitters T₁, T₂ and receivers R₁, R₂ may be acquired by activating the transmitters T₁, T₂ and collecting signals received at the receivers R₁, R₂ in response. From the two transmitters T₁, T₂ and two receivers R₁, R₂, four signals or measurements may be obtained: from the first transmitter T₁ to the first receiver R₁ (T₁R₁); from the first transmitter T₁ to the second receiver R₂ (T₁R₂); from the second transmitter T₂ to the first receiver R₁ (T₂R₁); and from the second transmitter T₂ to the second receiver R₂ (T₂R₂). A generated ratio R of the non-compensated signals or voltages (e.g., measurements) can be represented as follows:

$$R = \frac{{V}_{T 1 R 1} {V}_{T 2 R 2}}{{V}_{T 1 R 2} {V}_{T 2 R 1}} \qquad Equation 1$$

where V_{T1R1} is the signal obtained at the first receiver R₁ when the first transmitter T₁ is transmitting, V_{T2R2} is the signal obtained at the second receiver R₂ when the second transmitter T₂ is transmitting, V_{T1R2} is the signal obtained at the second receiver R₂ when the first transmitter T₁ is transmitting, and V_{T2R1} is the signal obtained at the first receiver R₁ when the second transmitter T₂ is transmitting. These signals or measurements are non-compensated signals consisting of complex voltages. Consequently, each measurement exhibits a corresponding amplitude and phase.

The ratio R of the non-compensated signals indicates formation properties that may change over time for monitoring and positioning applications. Accordingly, the ratio R of the non-compensated signals or voltages may change with respect to time according to the following:

$$R = \frac{{V}_{T 1 R 1}^{t} {V}_{T 2 R 2}^{t}}{{V}_{T 1 R 2}^{t} {V}_{T 2 R 1}^{t}} \qquad Equation 2$$

where V^{t} is the non-compensated signal or measurement with respect to time. A compensated signal, according to the present disclosure, has the capability of cancelling any multiplicative effects for the transmitters T₁, T₂ and/or the receivers R₁, R₂ such as manufacturing differences, electronic differences, and drifts due to temperature changes or aging of the electronics, to ensure that the remaining changes observed and measured are relevant to the monitoring application. To this end, the measured signal V^{t}_{T1R1}, for example, may be rewritten in the form:

V′^{t}=C_{T1}^{t}C_{R1}^{t}V_{T1R1}^{t} Equation (3)

where V′^{t} is the voltage that is affected by the multiplicative effect on the first transmitter T₁ as present at the first receiver R₁ with respect to time, C^{t}_{T1} is an effect parameter on the first transmitter T₁ with respect to time, and C^{t}_{R1} is an effect parameter on the first receiver R₁ with respect to time. When the four-term ratio of the signals as described above are taken, the compensated signal can be written in terms of the ideal or true measurements, in the absence of any effects, as the multiplicative effects of the transmitters T₁, T₂ and the receivers R₁, R₂ cancel out as follows:

$$R ( t ) = \frac{{V}_{T 1 R 1}^{t} {V}_{T 2 R 2}^{t}}{{V}_{T 1 R 2}^{t} {V}_{T 2 R 1}^{t}} = \frac{{C}_{T 1}^{t} {C}_{R 1}^{t} {V}_{T 1 R 1}^{t} {C}_{T 2}^{t} {C}_{R 2}^{t} {V}_{T 2 R 2}^{t}}{{C}_{T 1}^{t} {C}_{R 2}^{t} {V}_{T 1 R 2}^{t} {C}_{T 2}^{t} {C}_{R 1}^{t} {V}_{T 2 R 1}^{t}} = \frac{{V}_{T 1 R 1}^{′ t} {V}_{T 2 R 2}^{′ t}}{{V}_{T 1 R 2}^{′ t} {V}_{T 2 R 1}^{′ t}} \qquad Equation 4$$

It can be seen from Equation (4) that the compensated signal ratio R(t) is effectively independent of effects on individual sensors. The types of effects that may be eliminated may include, but are not limited to, unknown or varying transmitter signal magnitude, unknown or varying receiver amplification, unknown transmitter and receiver phase, certain variations in sensor orientations, certain variations in sensor positions, differences in sensor electronics, and differences in sensor type.

In some embodiments, the compensation process or operation may also be extended to time-domain systems S. In such processing, the time domain signal can be converted into a frequency domain signal by a transformation function. For example, the compensated signal may be recorded as a function of time, and a difference in time may be taken to obtain a time-lapse measurement. In general, a function ƒ can be used before the subtraction as shown below:

S(t₁,t₂)=ƒ(R(t₁))−ƒ(R(t₂)) Equation (5)

In some embodiments, function ƒ may be characterized using the linear identity function ƒ(x)=x. In other embodiments, function ƒ may be characterized as the logarithmic function ƒ(x)=log(x), which makes S indicate the logarithmic change in the signal levels between time t₁ and t₂. In yet other embodiments, function ƒ may be characterized as the second difference of measurements at three different times. Function ƒ(x) is ideally set to linearize the behavior of the flood 216 in time as much as possible for the given practical set of environmental conditions that are considered. The time lapse between times t₁ and t₂ may range, depending on the application. In some embodiments, the time lapse between measurements may be as little as a few minutes (e.g., 2-5 minutes). In other embodiments, however, the time lapse between measurements may encompass several minutes (i.e., more than 5), an hour, multiple hours, a day, multiple days, a week, multiple weeks, a month, multiple months, and any combination thereof.

Multiple time lapses may be used to produce information with a variety of resolutions that can be used to better detect the flood 216. For example, a short time lapse may better characterize the behavior of the flood, however it may measurements wherein the true values of the measured fields may be lower than the noise level. On the other hand, a long time lapse may not easily characterize the changing behavior of the flood, however, it produces measurements where the true values can be more easily detected in the presence of noise. Those skilled in the art will readily recognize other functions that may be employed without departing from the scope of the disclosure. Consequently, the examples provided here should not be considered as limiting the scope of the disclosure.

Referring now to FIG. 3, with continued reference to FIGS. 1 and 2, illustrated is a method 300 of compensating for effects on measured signals, according to one or more embodiments. The method 300 may include obtaining data from different sensors at time t₁ and time t₂, as at 302. The data may be obtained from various source types, meaning that it could be derived from varying types of receivers R₁, R₂, not just magnetic or electric dipole receivers, for example. This obtained data over a predetermined time lapse, as described above, may represent un-compensated, raw data derived from the receivers R₁, R₂ and may be used to obtain additional information regarding the subterranean formation 202 (FIG. 2) or other environmental parameters. To this end, the sensor data at each time t₁, t₂ may optionally be preprocessed, as at 304.

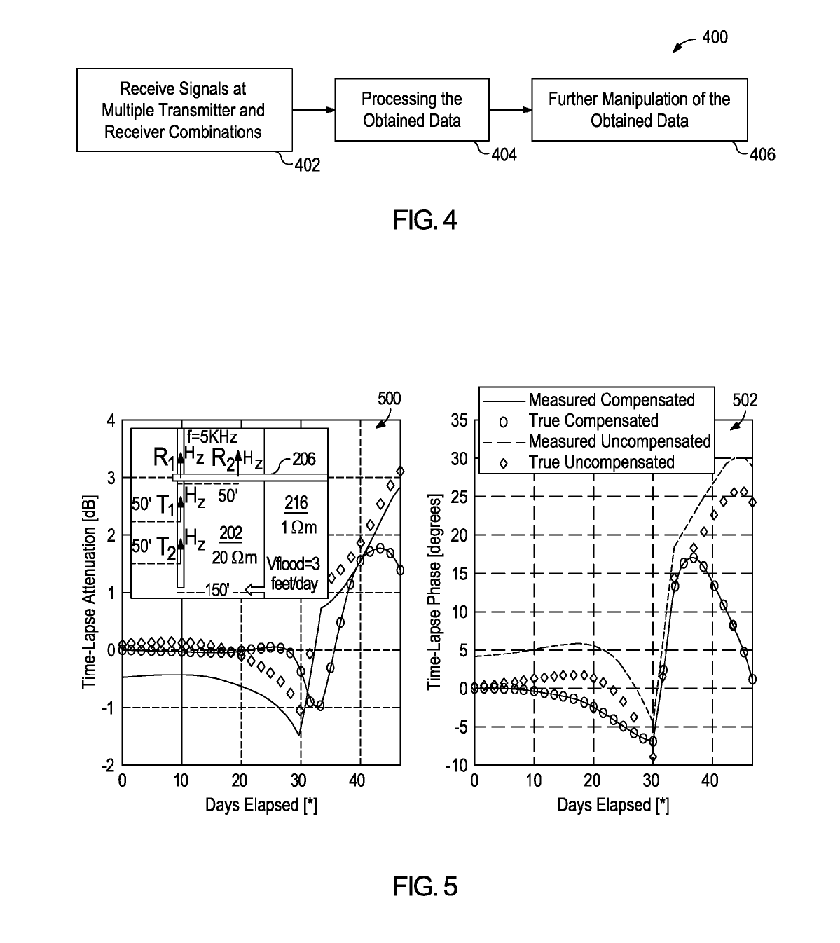

Referring to FIG. 4, with continued reference to FIG. 3, illustrated is a flow chart 400 describing various preprocessing actions that may be undertaken, as at 304 of FIG. 3, according to one or more embodiments. It should be noted that the flow chart 400 includes several steps or processes that can be implemented to preprocess the obtained data, but not necessarily in that order nor comprehensively. As depicted in the flow chart 400, the signals may be gathered using multiple transmitter and receiver combinations, as at 402. In other words, as discussed above with reference to the example provided in FIG. 2, the signals may be transmitted by transmitters and received at receivers in combinations of at least T₁R₁, T₁R₂, T₂R₁, and/or T₂R₂.

The multiple transmitter and receiver combinations may be called “channels,” and measurements made for each of the multiple channels at multiple frequencies. Moreover, multiple antenna orientations at each channel may also be implemented. Since each receiver R₁, R₂ has antennas arranged at multiple angular orientations (i.e., along the x, y, and z axes), measurements may be obtained at different rotation angles. Measurements can be made either while drilling, or while drilling has been stopped. In the present disclosure, measurements may be made as the sensors are permanently emplaced in the production and lateral wells 204, 206.

After accumulating this measurement data, the accumulated data may be preprocessed, as at 404. In some embodiments, preprocessing the accumulated data may include performing multi-component synthesis. In multi-component synthesis, information from measurements that were made in different orientations are combined at different orientations and different dipole orientations to create synthetic data which emulates a multi-component tool. Although the tool may not physically be multi-component, by making measurements at different orientations, it is possible to obtain data that effectively came from a multi-component tool.

In other embodiments, preprocessing the accumulated data may include software synthesis of non-present hardware configurations. This may entail processing measurements that were taken with certain signal angles on the transmitting or receiving antenna to obtain a different synthesized signal angle. This process uses a combination of two crossed antennas to provide a second orientation. After using the crossed antenna combination, the results can be added to obtain the Z-directed component or subtracted to obtain the radial component. Different signal angles can be obtained, depending on how the antenna signals are processed.

In yet other embodiments, preprocessing the obtained data may include using delayed virtual antenna elements, which may entail making a measurement at a specific depth, then making another measurement at a different depth. The two measurements are then combined and treated as if each measurement was performed at the same time.

Once the accumulated data has been preprocessed, the preprocessed data may be further manipulated, as at 406. In some embodiments, for example, the preprocessed data may be filtered for noise, which makes it possible to remove horn effects and to perform trigonometric fitting. For instance, in a case where transmitters or receivers are placed on a LWD sensor and when data is received from measurements are taken at different rotational angles of the LWD sensor, the measured values of a common field may be sinusoidally related to the rotational angle of the LWD sensor. As can be appreciated, making measurements at a number of different rotational angles generates a great deal of data. If there were 32 bins of rotation angles, for example, then there would be 32 measurements to transmit uphole. Since this is a large volume of information, it may prove advantageous to reduce its size. In addition, different measurements may include noise. This problem may be addressed by fitting a sinusoidal function to each set of measurements because it is known a priori that it should be like a sinusoid, and then only one number must be transmitted uphole. This function helps the transmission of data uphole since the transmitted information is reduced to just one number or two numbers, for example corresponding to the amplitude and the phase for the fitted sinusoid, for each set of measurements. Trigonometric filtering also enables a reduction in the data and reduces the noise, which makes it easier to process and to transmit.

Manipulating the obtained data may further include inversion processing to correct borehole effects in cases where transmitters or receivers are placed in an open hole. Similar processing may be performed for cased hole to correct for cement or casing effects. For example, the resistivity of cement or casing can be measured before or after they are placed in the well. Furthermore, the resistivity of a borehole or subterranean formation may be approximated by measuring the resistivity of cuttings and the mud during the drilling operations. Devices can also be used to measure the borehole size with calipers. This information can be used with a correction table to correct for borehole effects.

Manipulating the accumulated data may further include performing temperature corrections through the use of correlation tables or performing “software focusing.” Software focusing is a procedure that uses multiple measurements at different depths. These different measurements are combined with different depths of investigation and different vertical resolutions to derive a scientific measurement of a desired depth of investigation and/or vertical resolution.

Referring again to FIG. 3, following the optional preprocessing of the obtained or accumulated data, as at 304, compensated signal calculation may be undertaken, as at 306. The processing to obtain the compensated signals may be accomplished as generally described above. In some embodiments, the ratios used in the compensation processing can also be calculated by hardware through measuring phase difference and attenuation in between the receivers R₁, R₂, rather than measuring the absolute signals. This is due to the fact that the compensation process is equivalent to addition and subtraction of signals in logarithmic amplitude, and also in linear phase as shown below, where | . . . | denotes the absolute value of complex signals, and ∠ is the phase angle of complex signals.

$$\begin{matrix}\begin{matrix}log ( R ( t ) ) = log ( \frac{{V}_{T 1 R 1}^{′ t} {V}_{T 2 R 2}^{′ t}}{{V}_{T 1 R 2}^{′ t} {V}_{T 2 R 1}^{′ t}} ) \\ = log ( {V}_{T 1 R 1}^{′ t} ) + log ( {V}_{T 2 R 2}^{′ t} ) - log ( {V}_{T 1 R 2}^{′ t} ) + log ( {V}_{T 2 R 1}^{′ t} )\end{matrix} & Equation ( 6 ) \\ log ( \vert R ( t ) \vert ) = log ( \vert {V}_{T 1 R 1}^{′ t} \vert ) + log ( \vert {V}_{T 2 R 2}^{′ t} \vert ) - log ( \vert {V}_{T 1 R 2}^{′ t} \vert ) + log ( \vert {V}_{T 2 R 1}^{′ t} \vert ) \\ ∠ ( R ( t ) ) = ∠ ( {V}_{T 1 R 1}^{′ t} ) + ∠ ( {V}_{T 2 R 2}^{′ t} ) - ∠ ( {V}_{T 1 R 2}^{′ t} ) + ∠ ( {V}_{T 2 R 1}^{′ t} ) & \end{matrix}$$

These addition and subtraction operations can be performed by measuring the phase difference or attenuation in either hardware or software or a combination thereof. For example, the operations may be performed using the software program discussed above. A further time-lapse processing may also be applied on the compensated signal at this point, as generally described above.

In some embodiments, an inversion operation or calculation may be performed based on the compensated signal, as at 308. The inversion may prove advantageous in determining parameters of the subterranean formation 202, such as the resistivity of the formation 202 itself or of characteristics of an oncoming flood 216, such as volumetric resistivity distribution of the flood or a parameterization of it, for example. Performing an inversion operation may include using a forward model 310 and/or a library 312. The forward model 310 provides a set of mathematical relationships for sensor response that can be applied to determining what a selected sensor would measure in a particular environment, which may include a particular formation (i.e., subterranean formation 202 of FIG. 2). The library 312 may include information regarding various formation properties that can be correlated to measured responses to selected probe signals or measurements of certain transmitted fields.

An inversion operation may entail performing an iterative process and/or undertaking a pattern matching process. In particular, inversion may be performed by iteratively comparing any signal, with one possibility being the compensated signals from the compensation processing of 306, with values obtained by the forward model 310 or otherwise stored in the library 312. In at least one example of iterative use of the forward model 310, an initial value or guess of a property (e.g., conductivity) of a formation and a forward model may be applied to the initial value. The forward model provides a response, and the response is compared with a measured value and a next guess is generated based on the comparison. The comparison process continues to adjust the guess until the values of the forward model and the measured results agree.

The library 312 can be used with a pattern-matching inversion process. The library 312 may include correspondences between a physical measurement and a property or an identification of the nature of a physical entity that generated a particular electromagnetic or acoustic field in response to a probe signal. For example, measurement of a specific voltage or field can be mapped to a specific type of reservoir, subterranean formation, or flood. By comparing the measured value with a library including such values, a parameter of the reservoir, formation, or flood can be obtained from the library by the matching process. In some embodiments, a pattern of measured voltages can be matched to voltages in the library to identify the desired parameter.

Outputs from inversion 308 can include parameters associated with a reservoir, such as depth, thickness, resistivity, and/or shape. The contrast between properties of the identified reservoir and its surrounding formations can be used to provide images of the region that include the underground reservoir. Outputs from inversion 308 can also include other parameters associated with the subterranean formation 202, such as environmental parameters that may include borehole size or the nature of a flood 216 as it advances within the formation 202. For example, inversion 308 may be configured to determine resistivity, tilt of a formation bed, position of the front of a flood 216, the shape of the flood 216, resistivity distribution of a flood 216, anisotropy, etc. Moreover, since such measurements are time-lapsed, inversion may also be useful in determining the speed or flow rate of a flood 216 through the formation 202 and its estimated time of arrival to the production well 204.

It will be appreciated that the use of compensated signals in inversion 308 may help reduce or eliminate effects associated with amplitude or phase shift attributable to electronic drift, drift as a result of temperature change, unknown phases or amplitudes, manufacturing and electronic differences of the transmitters and receivers, or other unknown sensor parameters. Overcoming such perturbing or multiplicative effects may be important in controlled source measurements, which use a large number of sensors, since each sensor may have a different strength or gain due to differences in placement within the downhole environment. Moreover, since forward models 310 and libraries 312 typically do not include these effects, any reduction of these perturbing effects provided by the compensation operation translates to improved inversion performance. Without such reductions, an inversion system may need to parameterize and solve for these effects as well, which can reduce the inversion performance and stability. As a result, the compensation processing methods and systems described herein may prove advantageous in reducing the burden and associated expenses on electronics. In addition, such compensation systems and processes can improve depth and accuracy in detecting subterranean formations 202 and an advancing flood 216, for example.

Referring now to FIG. 5, with continued reference to FIG. 2, illustrated are two plots 500 and 502 that provide the modeling results derived from the monitoring application of FIG. 2, according to one or more embodiments. As illustrated in the plot 500, the flood 216 is approaching the production well 204 and the sensor locations of the lateral well 206. A total of four antennas are used, shown as H_{z} at each of T₁, T₂, R₁, R₂, and each antenna H_{z} is separated from adjacent antennas H_{z} by a distance of about 50 feet. The formation 202 exhibits or is otherwise assumed to exhibit a resistivity of about 20 Ω·m, while the flood 216 exhibits or is otherwise assumed to exhibit a resistivity of about 1 Ω·m. Moreover, the speed (i.e., “V_{flood}”) of the flood 216 as advancing within the subterranean formation is (or is assumed to be) about 3 feet per day. In the illustrated example, the initial starting point of flood 216 within the formation 202 was about 150 feet away from the production well 204 and approximately 45 days of data is recorded for reference in the plot 500.

In order to demonstrate the robustness of the disclosed systems and methods of calculating compensated signals over time, a drift in complex gain of each transmitter T₁, T₂ and receiver R₁, R₂ is assumed. A time-lapse measurement or spacing of about 1.66 days (Δt=1.66 days) is also assumed, such that a function S above may be represented as follows: 1

$$S ( t ) = \frac{R ( t + Δ t )}{R ( t - Δ t )} \qquad Equation ( 7 )$$

Equation (7) represents a time-lapse processing operation and it is defined as a ratio of two measurements at times t+Δt, and t−Δt. Based on this definition, S(t) is expected to produce a value close to 1 when there is no flood movement or when the flood is farther than the range of the system, and other values when there is a flood movement in the measurement range.

In accordance with the principles of Equation (3) above, the effect parameters of the receivers R₁, R₂ may be represented as C^{t}_{R1}, which are defined, for this example, to linearly vary from 1 to 0.5+0.5i over the time period of day 0 to day 150, and C^{t}_{R2}, which linearly varies from 1 to 1.5+0.5i from day 0 to day 150. These values represent about 50 percent error in the measurement due to drifts. The exact values are arbitrarily chosen as an example and therefore should not be considered as limiting the present disclosure.

In accordance with Equation (4) above, the resulting compensated and uncompensated signals (i.e., measured and true) may therefore be represented as follows:

$$R ( t ) = \{ \begin{matrix}\frac{{V}_{T 1 R 1}^{′ t} {V}_{T 2 R 2}^{′ t}}{{V}_{T 1 R 2}^{′ t} {V}_{T 2 R 1}^{′ t}} & for measured compensated \\ \frac{{V}_{T 1 R 1}^{t} {V}_{T 2 R 2}^{t}}{{V}_{T 1 R 2}^{t} {V}_{T 2 R 1}^{t}} & for true compensated \\ \frac{{V}_{T 1 R 1}^{′ t}}{{V}_{T 1 R 2}^{′ t}} & for measured uncompensated \\ \frac{{V}_{T 1 R 1}^{t}}{{V}_{T 1 R 2}^{t}} & for true uncompensated\end{matrix} \qquad Equation ( 8 )$$

where the measured compensated and uncompensated formulae include the drifts and/or multiplicative effects and the true compensated and uncompensated formulae do not include the drifts and/or multiplicative effects.

The plot 500 represents or otherwise provides monitoring details of how the attenuation of the transmitter T₁, T₂ and receiver R₁, R₂ signals have changed over time, and plot 502 represents or otherwise provides monitoring details of how the phase of the transmitter T₁, T₂ and receiver R₁, R₂ signals have changed over time. As can be seen from each plot 500, 502, the compensated measurements are not affected from phase shifts while the uncompensated measurements are adversely affected. This demonstrates that the compensated ratios can remove multiplicative effects even though an error as large as 50% was introduced.

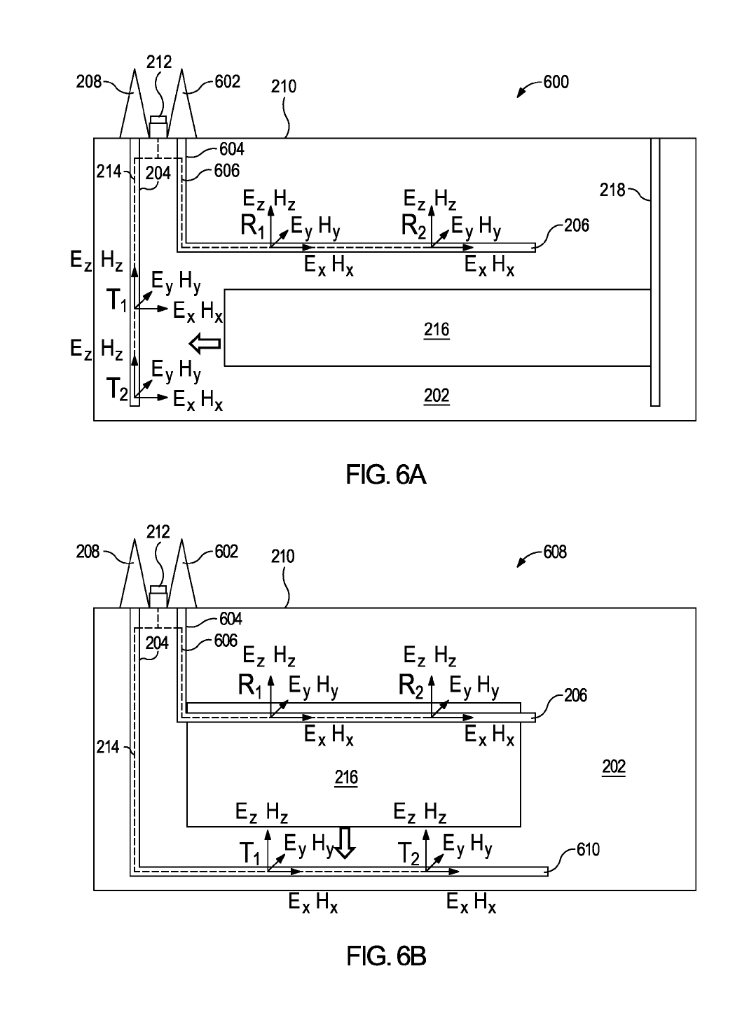

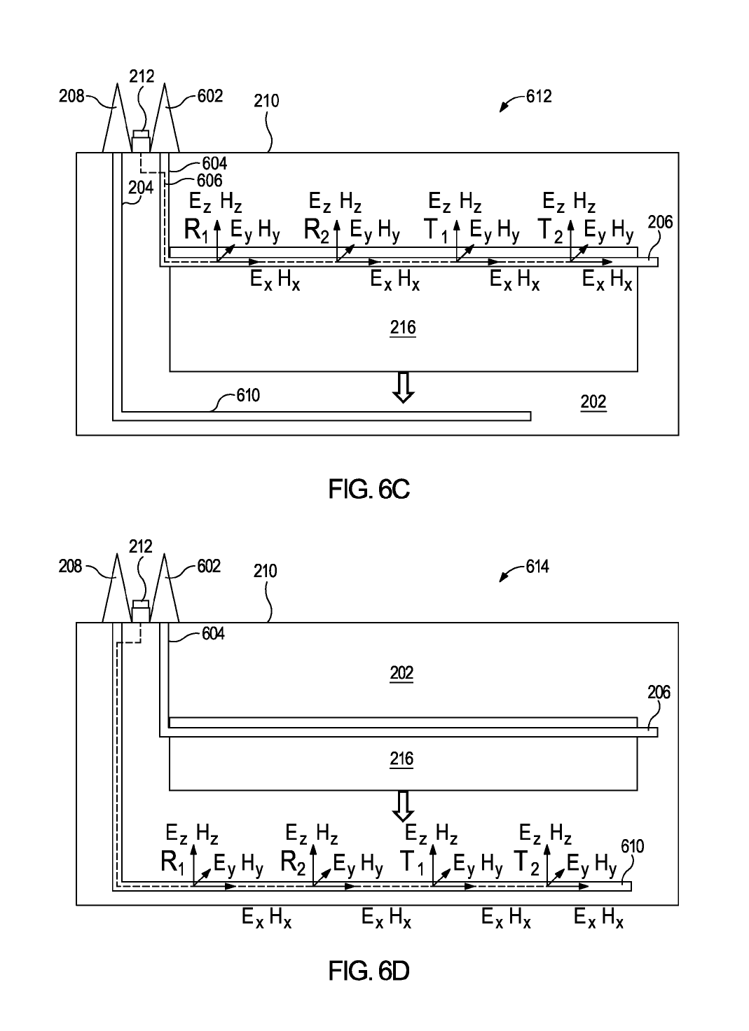

Referring now to FIGS. 6A-6D, with continued reference to FIGS. 1 and 2, illustrated are additional exemplary measurement systems for monitoring the subterranean formation 202, according to one or more embodiments. The measurement systems in FIGS. 6A-6D may be similar in some respects to the measurement system 200 of FIG. 2, where like numerals will represent like components not described again in detail. Similar to the measurement system 200 of FIG. 2, the measurement systems depicted in FIGS. 6A-6D may each include the production and lateral wells 204, 206, the service rig 208 and data processing unit 212 arranged at the surface, and at least four sensors, shown as two transmitters T₁, T₂ and two receivers R₁, R₂. Moreover, similar to the measurement system 200, each measurement system of FIGS. 6A-6D may be configured to employ the principles and processing capabilities of the data acquisition system 100 of FIG. 1. Unlike the measurement system 200, however, the measurement systems of FIGS. 6A-6D may each include an additional service rig 602 fluidly coupled to the lateral well 206 via a vertical well portion 604.

In FIG. 6A, the measurement system 600 includes the injection well 218 that injects the flood 216 into the subterranean formation 202 and the transmitters T₁, T₂ and receivers R₁, R₂ work in conjunction with the data acquisition system 100 (FIG. 1) to provide the compensated signals. In some embodiments, such calculations are undertaken entirely downhole, as described above. In other embodiments, however, the data processing unit 212 at the surface 210 may be configured to receive data and generate the compensated signals. As illustrated, the data processing unit 212 may be communicably coupled to the transmitters T₁, T₂ via the communication line 214 and communicably coupled to the receivers R₁, R₂ via one or more additional communication lines 606 extending within the vertical well portion 604 and the lateral well 206. Similar to the communication lines 214, the communication lines 606 may be any form of wired or wireless technology allowing the receivers R₁, R₂, or the communication unit 122 of FIG. 1, to communicate with the data processing unit and/or an operator at the surface 210.

In FIG. 6B, the injection well 218 is omitted in the illustrated measurement system 608. Instead, the lateral well 206, in conjunction with the additional service rig 602, may serve as the injection well and may thereby inject the flood 216 into the formation 202. The transmitters T₁, T₂ may be generally arranged in a second lateral well 610 that extends from the production well 204. The progress and nature of the flood 216 within the formation 202, along with the other parameters and characteristics discussed herein, may be determined or otherwise monitored using the measurement system 608, in conjunction with the data acquisition system 100 of FIG. 1.

In FIG. 6C, the measurement system 612 may have each of the transmitters T₁, T₂ and receivers R₁, R₂ arranged within the lateral well 206. Similar to the measurement system 608 of FIG. 6B, the lateral well 206 may serve as the injection well, thereby injecting the flood 216 into the formation 202 toward the second lateral well 610. As will be appreciated, arranging each of the transmitters T₁, T₂ and receivers R₁, R₂ within a common borehole (i.e., the lateral well 206) may prove advantageous during sensor deployment operations in saving time and cost.

In FIG. 6D, the measurement system 614 may have each of the transmitters T₁, T₂ and receivers R₁, R₂ arranged within the second lateral well 610. Again, the lateral well 206 may serve as the injection well, thereby injecting the flood 216 into the formation 202 toward the second lateral well 610.

The measurement system in FIG. 6B is expected to produce the largest signals since the average distance between sensors in minimized. On the other hand, the measurement systems 612 in FIGS. 6C and 6D have the longest average distances and, as a result, are expected to perform less efficiently.

As briefly mentioned above, the various sensors used in the exemplary systems and methods discussed herein may alternatively operate on the principle of acoustic waves or signals. Acoustic sensing technology can be used with all of the configurations or embodiments described herein for electromagnetic technology and the same relations will apply for compensation of the various sensors and associated electronics.

A number of acoustic modes can be used to assess formation 202 properties. The acoustic waves that are launched into the formation 202 and received therefrom propagate in a number of modes, the simplest of which is a compressional mode. The fluid in a borehole will not support shear waves, but shear waves can be generated at the interface between a borehole and the formation 202 and can be tracked based on their wave speed (as viewed across an array of receivers), which is typically much less than that of compressional waves.

Since fluids do not transmit shear in the frequency bands of interest, the propagation of shear waves is relatively uninfluenced by the presence of formation 202 fluids, whereas the propagation of compressional waves is influenced by formation 202 fluids. Hence, in monitoring the advance of an approaching flood 216, such as a water flood, it may prove advantageous to monitor both shear and compressional components.

It should be noted that if contact is established between an acoustic transmitter and the formation 202, it may be possible to directly launch shear waves into the formation 202. Similarly, it may be possible to directly receive shear waves if the receiver(s) are in contact with the formation 202. In this case, the transducer used to detect shear waves should be set up so as to respond to shear motion, which is parallel to the borehole wall, whereas a transducer that is responsive to compressional motion will have its axis of response orthogonal to the borehole wall (however, if the transducers are separated from the borehole by a fluid, they will respond only to compression).

Other types of modes that are of interest in borehole acoustics are identified in “Acoustic Waves in Boreholes,” Frederick L. Paillet, Chuen Hon Chang, CRC Press Inc., Boca Raton, 1991, the contents of which are incorporated herein by reference.

With a few exceptions, most acoustic transmitters suitable for the present disclosure may also function as receivers and are simply called acoustic transducers. Exemplary acoustic transducers that may be used include, but are not limited to, piezoelectric and magnetostrictive transducers. Such transducers may be in the form of a single plate or a stack of plates or in the form of what those skilled in the art call a “bender bar.” Those skilled in the art will readily recognize that these transmitters may be so configured to act as monopole, dipole, quadrupole or higher moment sources.

Briefly, a monopole acoustic source in a borehole sends out pressure waves of equal amplitude and phase in all directions from the source (until the waves interact with the formation 202). Monopole sources may be used for compressional wave logging and shear wave logging in what is termed “fast formations,” i.e., formations in which the shear wave speed is higher than the speed of compressional waves through the fluid in the borehole. A simple dipole can be thought of as a superposition of two identical point sources separated by a fixed distance and operating 180° out of phase with each other. Crossed dipole sources, which consist of two dipoles rotated about the sensor axis by 90° with respect to each other can be used to log shear wave velocities in “slow formations,” i.e., formations in which the shear wave speed is less than the speed of compressional waves through the fluid in the borehole. Quadrupole sources, as the term implies can be synthesized from four point sources, but more is required for a source to be a quadrupole source (e.g., the crossed dipoles discussed above are not quadrupole sources). A simple quadrupole source for acoustic logging would consist of four point sources (or nearly point sources) distributed at 90° intervals around the periphery of the logging tool and excited such that adjacent sources are 180° out of phase with each other and of the same amplitude. Quadrupole sources are typically preferred for low frequency shear wave logging.

In yet other embodiments, one or more of the transmitters used may be configured as having a hexapole source configuration, as generally described in U.S. Pat. No. 8,125,848, which is incorporated by reference. Those skilled in the art will readily appreciate that what serves as an acoustic transducer in accordance with the present disclosure may be a composite assembly of several acoustic transducers including, but not limited to, those described above.

Examples of additional transmitters that cannot function as receivers and that are sometimes used in conjunction with borehole acoustics include, but art not limited to, high voltage “sparkers” (as disclosed in U.S. Pat. Pub. No. 2011/0090764) that generate acoustic waves via an electric discharge, various types of hammers that may be used to strike against a formation 202, a drill bit, and a large variety of mechanical and hydraulic vibrators. Other suitable acoustic transducers and configurations that may be employed in the present disclosure are described in U.S. Pat. No. 7,513,147 to Yogeswaren, U.S. Pat. No. 7,036,363 to Yogeswaren, U.S. Pat. No. 6,213,250 to Wisniewski, et al., U.S. Pat. No. 6,063,363 to Goodwin, et al., U.S. Pat. No. 5,753,812 to Aron, et al., U.S. Pat. No. 5,644,186 to Birchak, et al., U.S. Pat. No. 5,063,542 to Petermann, et al., U.S. Pat. No. 4,782,910 to Sims, and U.S. Pat. No. 4,219,095 to Trouiller, the contents of each are hereby incorporated by reference.

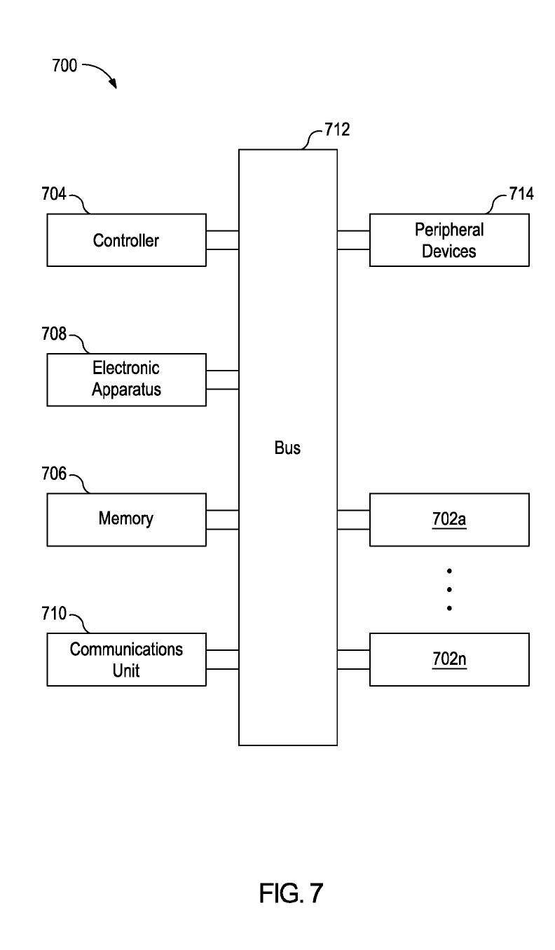

Referring now to FIG. 7, illustrated is a block diagram of features of an exemplary system 700 that may be used to process received signals at sensors to compensate for multiplicative effects and other perturbations on various measuring tools used, according to one or more embodiments of the disclosure. The system 700 may include various sensors 702a . . . 702n having arrangements of transmitters and receivers that may be arranged similarly or identical as discussed above. The system 700 may also include a controller 704, a memory 706, an electronic apparatus 708, and a communications unit 710.

The controller 704, the memory 706, and the communications unit 710 may be arranged to operate as a processing unit to compensate measurement signals provided by the sensors 702a-n over time and to perform one or more inversion operations on the time-lapsed compensated measurement signals to determine properties of an underground environment, such as the nature of a flood. The processing unit may be distributed among the components of the system 700 including the electronic apparatus 708, which may include circuitry that can generate a ratio or ratios of measured signals to compensate for perturbing or multiplicative measurement effects.

The controller 704, the memory 706, and the electronic apparatus 708 may be configured to control the activation of the transmitters and selection of receivers in the group of sensors 702a-n and to manage processing schemes in accordance with measurement procedures and signal processing as described herein. The communications unit 710 may include downhole communications for appropriately located sensors. Such downhole communications can include a telemetry system, for example. The communications unit 710 can further include communications operable among land locations, sea surface locations both fixed and mobile, and undersea locations both fixed and mobile. The communications unit 710 may use combinations of wired communication technologies and wireless technologies at frequencies that do not interfere with on-going measurements. With reference to FIG. 1, the memory 706 of FIG. 7 may be the same as the memory included in either the computer at the surface 124 and/or the system control center 114.

The system 700 may also include a bus 712 that provides electrical conductivity among the components of the system 700. The bus 712 can include an address bus, a data bus, and a control bus, each independently configured. The bus 712 may use a number of different communication mediums that allow for the distribution of components of the system 700 as shown with respect to FIGS. 1-3, and 6A-6D. Use of the bus 712 can be regulated by the controller 704.

In various embodiments, peripheral devices 714 may include displays, additional storage memory, and/or other control devices that may operate in conjunction with the controller 704 and/or the memory 706. In an embodiment, the controller 704 may encompass a processor or a group of processors that may operate independently depending on an assigned function. The peripheral devices 714 may be arranged with a display that can be used with instructions stored in the memory 706 to implement a user interface to manage the operation of the sensors 702a-n and/or components distributed within the system 700. Such a user interface can be operated in conjunction with the communications unit 710 and the bus 712.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A measurement system, comprising:
at least two transmitters and at least two receivers disposed within at least one borehole formed in a subterranean formation, wherein at least one of the at least two transmitters or the at least two receivers is permanently installed in the at least one borehole; and
a data acquisition system communicably coupled to the at least two transmitters and the at least two receivers and configured to activate the at least two transmitters and process two or more signals received from the at least two receivers in order to generate compensated signals that minimize or eliminate multiplicative effects, wherein at least one time-lapsed compensated signal is generated from a difference between a first compensated signal and a second compensated signal.

2. The measurement system of claim 1, wherein the at least two transmitters and the at least two receivers are one of magnetic dipole sensors, electric dipole sensors, acoustic transmitters, or acoustic sensors.

3. The measurement system of claim 2, wherein the magnetic dipole sensors or electric dipole sensors are selected from a group consisting of non-tilted coil antennas, tilted coil antennas, solenoid antennas, toroidal antennas, electrode-type antennas, transceivers, and combinations thereof.

4. The measurement system of claim 2, wherein the acoustic transmitters and acoustic sensors are selected from a group consisting of piezoelectric transducers, magnetostrictive transducers, sparker-type transmitters, hammer-type transmitters, a drill bit, mechanical vibrators, and hydraulic vibrators.

5. The measurement system of claim 1, wherein at least one of the at least two transmitters and the at least two receivers is a transceiver.

6. The measurement system of claim 1, wherein the at least one borehole is a production well.

7. The measurement system of claim 1, wherein the at least one borehole is an injection well configured to inject a flood into the subterranean formation.

8. The measurement system of claim 1, wherein the at least one borehole comprises a first borehole and a second borehole and the at least two transmitters and the at least two receivers are disposed in at least one of the first and second boreholes.

9. The measurement system of claim 8, wherein at least one of the first and second boreholes is a production well.

10. The measurement system of claim 8, wherein at least one of the first and second boreholes is an injection well.

11. The measurement system of claim 8, wherein the second borehole is a lateral borehole extending from the first borehole.

12. The measurement system of claim 8, wherein the data acquisition system is arranged in one of the first or second boreholes.

13. The measurement system of claim 1, wherein the multiplicative effects include amplitude or phase shifts that are attributable to electronic drift, drift as a result of temperature change, unknown phases or amplitudes, and manufacturing and electronic differences of the at least two transmitters and the at least two receivers.

14. The measurement system of claim 1, wherein the at least one time-lapsed compensated signal is derived by generating a ratio from the first and second compensated signals and performing an inversion operation on the ratio to determine properties of the subterranean formation that changed between a time t₁ and a time t₂.

15. The measurement system of claim 14, wherein the subterranean formation contains a flood and the compensated signals are indicative of a position of the flood at time t₁ and time t₂.

16. A method of monitoring a subterranean formation, comprising:
activating at least two transmitters with a data acquisition system communicably coupled thereto;
collecting signals received by at least two receivers with the data acquisition system, wherein the at least two transmitters and the at least two receivers are disposed within at least one borehole formed in the subterranean formation; and
generating compensated signals from the signals collected with the data acquisition system.

17. The method of claim 16, wherein the compensated signals comprise at least a first compensated signal calculated at a time t₁ and a second compensated signal calculated at a time t₂, wherein time t₂ is greater than time t₁, and wherein generating the compensated signals comprises:
generating a difference of an analytical function of the first and second compensated signals; and
performing an inversion operation on the difference to determine properties of the subterranean formation that changed between time t₁ and time t₂ such that a time-lapsed compensated signal is generated.

18. The method of claim 17, wherein at least one property of the subterranean formation includes a position of a flood within the subterranean formation, the method further comprising determining the position of the flood at time t₁ and time t₂.

19. The method of claim 16, wherein the at least one borehole is a production well or an injection well configured to inject a flood into the subterranean formation.

20. The method of claim 16, wherein the at least one borehole comprises a first borehole and a second borehole and the at least two transmitters and that at least two receivers are disposed in either or both of the first and second boreholes.

21. The method of claim 20, wherein at least one of the first and second boreholes is a production well.

22. The method of claim 20, wherein at least one of the first and second boreholes is an injection well configured to inject a flood into the subterranean formation.

23. The method of claim 20, wherein the second borehole is a lateral borehole extending from the first borehole.

24. The method of claim 16, further comprising using the compensated signals to minimize or eliminate multiplicative effects comprising at least one of amplitude or phase shifts that are attributable to electronic drift, drift as a result of temperature change, unknown phases or amplitudes, and manufacturing and electronic differences of the at least two transmitters and the at least two receivers.

25. A non-transitory, computer readable medium programmed with computer executable instructions that, when executed by a processor of a computer unit, performs the method of claims 16 to 24.
